(19) United States
(12) Patent Application Publication
(10) Pub. No.: US 2001/0006360 A1
(43) Pub. Date: Jul. 5, 2001

(54) Microwave filter

(75) Inventors: Byung Du Oh, Seoul (KR); Young Hwan Choi, Seoul (KR); Byoug Chul Min, Seoul (KR); Irina Vendik, St. Peterburg (RU); Anatoli Deleniv, St. Petersburg (RU); Vladimir Cherman, St. Petersburg (RU)

Correspondence Address: The Law Offices of, FLESHNER & KIM, P.O. Box 221200, Chantilly, VA, 20153-1200, US

(73) Assignee: LG Electronics Inc.

(21) Appl. No.: 09/740,849

(22) Filed: Dec. 21, 2000

(30) Foreign Application Priority Data
Dec. 23, 1999 (KR) 61263/1999

(51) Int. Cl. H01P 1/203; H01B 12/02

(52) U.S. Cl. 333/99 S; 505/210

(57) ABSTRACT

A microwave filter is disclosed, which filters only a signal of a desired band in a radio communication system. The microwave filter includes a plurality of feed lines and resonators on an upper portion of a substrate, and a ground surface below the substrate. Each of the resonators includes coupled meander lines, the meander lines having three or more sections. The resonators are arranged in such a manner that the adjacent resonators are symmetrical to each other. The feed lines are formed at one side of the resonators at both edges, and are coupled spaced apart from the resonators in parallel to the resonators. Thus, the microwave filter can be fabricated at a small size because the meander-lined resonators have a small size. The microwave filter also has excellent transmission characteristics such as pseudo-elliptic characteristics.

### BACKGROUND OF THE INVENTION

1. Field of the Invention

The present invention relates to a microwave filter, and more particularly, to a microwave filter which filters only a signal of a desired band in a radio communication system.

2. Description of the Related Art

Processing RF signals in wireless communication systems like PCS (Personal Communications Services) or GSM (Global System for Mobile communications) requires highly selective filters with fractional bandwidth less than 1%. It is well known that the in-band insertion loss of the filters is inversely proportional to the bandwidth and depends on the conductor surface resistance and the filter order. On the other hand, a higher selectivity of a band pass filter is in general provided by increasing the number of poles (resonators). A realization of such filters in the planar structure using normally-conducting materials faces with an indispensably high insertion loss level. The implementation of high-temperature superconductors (HTS) makes possible a realization of ultra-narrowband planar filters with a low insertion loss and a higher selectivity.

To fabricate such a narrowband micro-strip filter, it is necessary to decrease coupling between resonators.

Generally, coupling between the resonators slowly decreases depending on the distance. Accordingly, it is necessary to widen the distance between the resonators so as to decrease coupling. This means that the size of the filter should be greater.

However, the size of a super conductive thin film that can be fabricated by a conventional method is 2 inch to 3 inch, approximately.

To fabricate a filter having a plurality of poles in a wafer having a limited size, it is necessary to properly select a type of a resonator.

A related art filter adopts a half-wavelength resonator or a hair-pin type resonator made by folding the half-wavelength resonator in half. If a resonator smaller than these resonators is adopted, a filter having a smaller size can be fabricated.

Furthermore, for fabrication of a filter, if an elliptic method or a pseudo-elliptic method not a Chebyshev method is adopted, a resonator having more excellent skirt characteristics can be obtained under the same condition.

Elliptic and quasi-elliptic characteristics are more appreciated for the highly selective filters over the Chebyshev characteristic. For a given filter order, the highest steepness of the characteristic is obtained with the elliptic (Cauer) approximation, featured by equal-ripple response in both passband and stopband. Furthermore, for a specified filter selectivity and a given quality factor of resonators, the elliptic filters have a minimum in-band insertion loss. The elliptic response can be provided by using cross couplings between nonadjacent resonators. One difficulty in realizing the cross-coupled planar filters is to identify and control the required electric and magnetic nonadjacent couplings between all resonators.

The filters with quasi-elliptic characteristic proposed by Levy are less complicated in design with respect to the elliptic ones. Due to transmission zeros at finite frequencies close to the cut-off of the passband, a quasi-elliptic filter has sharper slopes than the Chebyshev filter, described by the polynomial of the same order. The steepness of the filter characteristic increases at the cost of a reduced attenuation far from the passband edges.

In this respect, a small sized filter having excellent skirt characteristics in the same manner as the pseudo-elliptic method will be required later. In this invention we propose a novel configuration of planar resonators providing the quasi-elliptic filter characteristic.

### SUMMARY OF THE INVENTION

Accordingly, the present invention is directed to a microwave filter that substantially obviates one or more of the problems due to limitations and disadvantages of the related art.

An object of the present invention is to provide a microwave filter having a small size and excellent transmission characteristics.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a microwave filter according to the present invention includes a plurality of feed lines and resonators on an upper portion of a substrate, and a ground surface below the substrate.

In the preferred embodiment of the present invention, each of the resonators includes coupled meander lines, the meander lines having three or more sections. The resonators are arranged in such a manner that adjacent resonators are symmetrical to each other.

The specific symmetry of the structure provides the frequency response with two transmission zeroes at finite frequencies in contrast to the conventional half-wavelength straight and hairpin coupled resonators. The location of the transmission zeroes is defined by the inner spacing between the meander-line sections and the coupling (i.e. the distance) between the resonators.

The feed lines are formed at one side of the resonators at both edges, and are coupled spaced apart from the resonators in parallel to the resonators.

The microwave filter of the present invention can be fabricated at a small size because the meander-lined resonators have a small size. The microwave filter also has excellent transmission characteristics such as pseudo-elliptic characteristics.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention.

In the drawings:

FIG. 1 is a plane view and a sectional view showing a microwave filter according to the present invention;

FIG. 2 is a comparison graph showing transmission characteristics of a microwave filter of the present invention and various five-pole filters; and

FIG. 3 is a graph showing transmission characteristics of a twelve-pole microwave filter according to the present invention.

### DETAILED DESCRIPTION OF THE PREFERRED EMBODIMENTS

Reference will now be made in detail to the preferred embodiments of the present invention, examples of which are illustrated in the accompanying drawings.

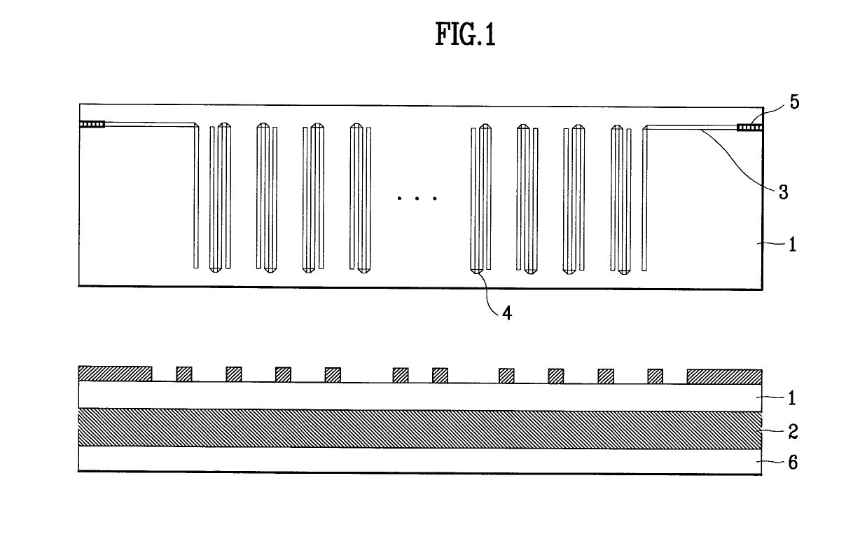

FIG. 1 is a plane view and a sectional view showing a microwave filter according to the present invention.

As shown in FIG. 1, the microwave filter of the present invention includes a substrate 1, a ground surface 2, feed lines 3, resonators 4, and connecting pads 5. The substrate 1 is formed of a material such as LaAlo₃ or MgO. The ground surface 2 acts to enhance ground between a filter and a filter package, and is formed of a super conductor such as YBa₂Cu₃O7_{-δ}. A gold thin film 6 is formed on the ground surface 2.

The feed lines 3 and the resonators 4 are formed of a super is conductor. The connecting pads 5 are formed by forming a gold thin film on the super conducting feed lines such as YBa₂Cu₃O7_{-δ}, so that the feed lines 3 and the resonators 4 are connected with a microwave connecting element such as SMA connector.

The resonators 4 have a meander-lined shape. The meander lines have three or more sections. The resonators 4 are arranged in such a manner that the adjacent resonators are symmetrical to each other.

Such a symmetrical characteristic of the resonators 4 generates two additional poles at both edges of a pass band in the same manner as transmission characteristics of a pseudo-elliptic method.

The central frequency of the pass band and the location of the poles are determined by the length of the meander-line section of each resonator and the distance between the sections of the meander line.

The number of the resonators can be controlled depending on a desired option. The distance between the resonators is determined depending on which type of a filter is fabricated.

For convenience, a small number of the resonators are shown in the drawing.

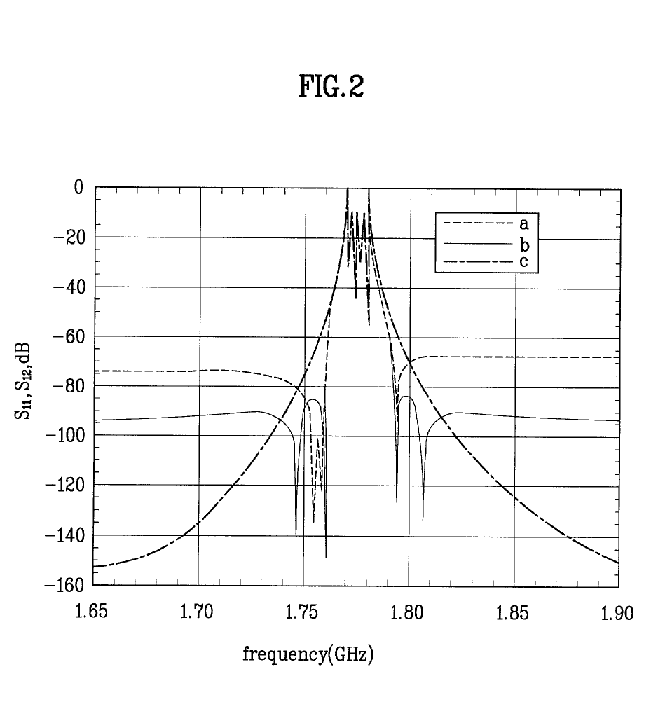

FIG. 2 is a comparison graph showing transmission characteristics of a microwave filter of the present invention and various five-pole filters.

Referring to FIG. 2, graph (a) shows transmission characteristic of the microwave filter according to the present invention, graph (b) shows transmission characteristic of a micro-strip filter according to a Cauer method, and graph (c) shows transmission characteristic of a micro-strip filter according to a Chebyshev method.

As shown in FIG. 2, the Cauer method shows the most excellent skirt characteristic under the same condition, i.e., the same number of the resonators. However, it is almost impossible to actually implement the Cauer method in the micro-strip filter.

The Chebyshev method is the easiest to be implemented in the micro-strip filter.

However, it is noted that the microwave filter of the present invention shows more excellent skirt characteristic than that of the Chebyshev method while it is easy to be implemented in the micro-strip filter in the same manner as the Chebyshev method.

Accordingly, in the present invention, as shown in FIG. 2, the micro-strip filter can simply be implemented at a small size and transmission characteristic approximate to the Cauer method can be obtained. This means that an unwanted signal can be shielded more effectively.

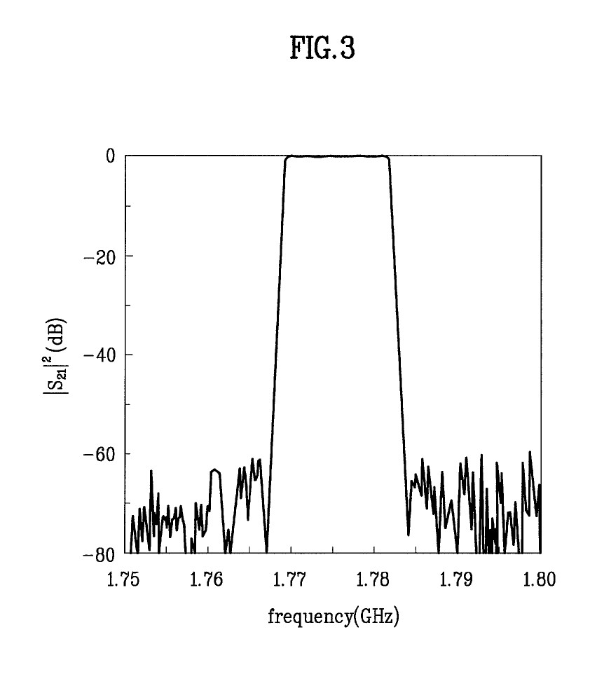

FIG. 3 is a graph showing transmission characteristics of a twelve-pole microwave filter according to the present invention.

Referring to FIG. 3, the small input loss of about 0.3 dB is shown within the pass band. The fractional bandwidth defined by a pass band width to central frequency ratio is about 0.5% that means a very narrow pass band characteristic. The steep skirt characteristic having the frequency band of about 40 dB/MHz is shown.

These characteristics mean that the microwave filter of the present invention is more excellent than the related art filter.

As described above, the microwave filter having excellent characteristics can be fabricated. If the microwave filter of the present invention is mounted in a radio communication subsystem such as cellular phones(DCN), PCS, GSM, IMT2000, and LMDS, performance of the system can be improved.

As aforementioned, the microwave filter of the present invention has the following advantages.

Since the resonators consisting of the meander lines having two or more sections are symmetrically arranged, excellent transmission characteristic such as pseudo-elliptic characteristic can be obtained. Also, since the meander-lined resonators are used, an area occupied by the filter can be reduced as compared with an inter-digital filter or a hair-pin filter.

Furthermore, it is possible to additionally vary characteristics of the filter by varying the distance between the meander line sections of the resonators.

Moreover, since the filter of the present invention has a uniform and simple structure, high-speed simulation is possible when the filter is designed. Also, since the filter is a flat type, it is easy to fabricate the filter.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A microwave filter comprising:
a plurality of feed lines and resonators on an upper portion of a substrate; and a ground surface below the substrate, each of the resonators including coupled meander lines, the meander lines having three or more sections.

2. The microwave filter of claim 1, wherein the resonators are arranged in such a manner that the adjacent resonators are symmetrical to each other.

3. The microwave filter of claim 1, wherein the feed lines are formed at one sides of the resonators at both edges, and are coupled spaced apart from the resonators in parallel to the resonators.

4. The microwave filter of claim 3, wherein the feed lines are connected to connecting pads for input/output to the outside.

5. The microwave filter of claim 1, wherein the resonators, the feed lines, and the ground surface are formed of a super-conductor.

6. The microwave filter of claim 1, further comprising a gold thin film formed on the ground surface.
